(19) United States
(12) Patent Application Publication
(10) Pub. No.: US 2003/0236773 A1
(43) Pub. Date: Dec. 25, 2003

(54) Input system and method with dynamic database adjustment function

(76) Inventors: Say Ling Wen, Taipei (TW); Zechary Chang, Taipei (TW); Leger Wu, Beijing (CN)

Correspondence Address: JACOBSON HOLMAN PLLC, 400 SEVENTH STREET N.W., SUITE 600, WASHINGTON, DC, 20004, US

(21) Appl. No.: 10/173,716

(22) Filed: Jun. 19, 2002

(51) Int. Cl. G06F 17/30

(52) U.S. Cl. 707/3

(57) ABSTRACT

A system and method of input with the function of dynamic database adjustment. The object of the invention is to increase input speed of a user by providing a convenient and adjustable database (i.e. for expanding and removing sentences). The system employs the method of dynamically retrieving a sentence from an editable file in another application program and processing divisions of the sentence to be expanded into the database while the input method is activated. It also enables the system to dynamically retrieve and display a chosen sentence from the database to be deleted upon the user's request.

### BACKGROUND OF THE INVENTION

1. Field of the Invention

The invention relates to an input system and method, and particularly a system and method of input with the function of dynamically adjusting a database by instantly expanding and removing sentences.

2. Related Art

The biggest problems of input methods are input speed and inconvenience. Although there are various and similar input methods everywhere, none of them at present has achieved a satisfactory solution to the aforementioned problems.

Generally, most input methods focus on resolving the problem of input speed. The way of resolving this problem to achieve the object of increasing input speed sometimes requires a user to develop his/her own unique input method of disassembling words. Therefore, before a user can truly increase input speed, s/he has to spend much time in self-training to become familiar with this unique disassembly. To the general public, it is too difficult and inconvenient to learn to use such a unique disassembled input method.

Some input methods attempt to resolve the problems of input speed and inconvenience by utilizing a database with built-in sentences. This solution enables a user to achieve the objects of rapid input and time saving by directly selecting a sentence from a built-in database. The kind of solution is not very satisfactory, though it resolves some of the problems. Such a built-in database may not satisfy the requirements of various situations with different user needs, as most of the sentences stored in the built-in database are limited in number and with restrictive attributes. It is doubtful that such a database with built-in sentences can truly enhance input speed if it cannot serve a user in most cases.

Even though there are many input methods providing databases with built-in sentences for a user to expand or remove sentences, those methods require additional application programs to execute the data expansion function. Under such a situation, a user cannot simultaneously process data expansion while inputting data, meaning that the operations of both data input and sentence expansion have to be separately processed, which causes inconvenience to users. So does the function of deleting a stored sentence in the database. Thus, this kind of adjustable database design seems to be inconvenient and inflexible and further reduces a user's interest in using the database expansion function.

### SUMMARY OF THE INVENTION

In view of the foregoing, the disclosed invention aims at resolving the above-mentioned problems with a system and method of input with a dynamic database adjustment function. The main object of the invention is to increase the convenience of adjusting the database. The secondary object of the invention is to increase input speed by simplifying unnecessary procedures.

To achieve the aforementioned objects, the proposed input method with the function of dynamic database adjustment includes: a database, an input interface module, a contrast and display module and a database adjustment module.

The disclosed input method with the function of dynamic database adjustment basically includes two sections: sentence expansion and sentence removal, in which the sentence expansion section consists of the following steps: opening an editable file from one application program, starting the input interface of the application program, selecting a sentence from the editable file, and confirming that the sentence is stored in the database through the input interface. The sentence removal section consists of the following steps: starting the input interface, inputting the initial word of a sentence that is to be deleted, contrasting all sentences in the database starting with the same inputted initial word, displaying all matched contents, and removing the sentence from the database through defined set-up keys of the system.

### BRIEF DESCRIPTION OF THE DRAWINGS

FIG. 1 shows a systematic structure of the disclosed system and method of input with a dynamic database adjustment function;

FIG. 2-a shows a flowchart for expanding the database according to the disclosed system and method;

FIG. 2-b shows a detailed flowchart of expanding the database according to the disclosed system and method;

FIG. 3 shows a flowchart for removing the database according to the disclosed system and method;

FIG. 4 shows an illustrated representation of expanding the database according to the disclosed system and method;

FIG. 5 shows an illustrated representation of removing the database according to the disclosed system and method.

### DETAILED DESCRIPTION OF THE INVENTION

The disclosed invention proposes an input system and method with a dynamically adjusting database function that can be started among editable files of any application program to dynamically adjust the database (i.e. expansion and removal).

The detailed contents and technologies of the invention will be elaborated by means of embodiments and drawings depicted in the following.

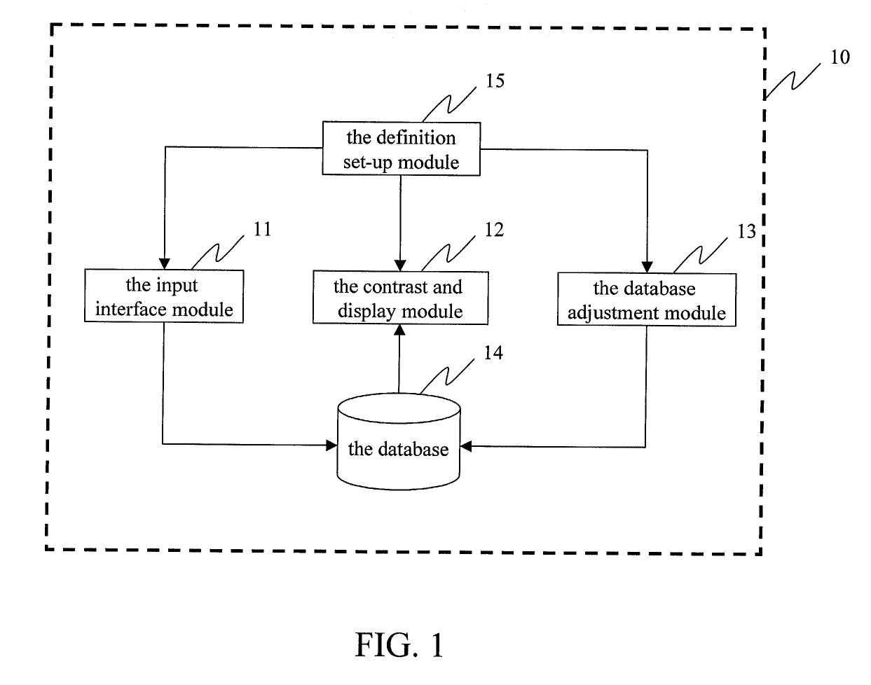

As shown in FIG. 1, the systematic structure of the disclosed system and method of input with the dynamic database adjustment function is as follows.

(1)The input interface module 11 is mainly responsible for providing an input interface for a user to start up the system, so that the user is able to process switching different input modes through the input interface module, including switching input languages (e.g. simplified/traditional Chinese, Chinese/English), switching input modes (e.g. words, phrases, or sentences), switching input status (e.g. words, punctuation marks, special symbols). In addition, it enables a user to execute the functions through the action of click (e.g. confirming sentence expansion). It is very important that it enables a user to use a kind of selection method.

(2)The contrast and display module 12 compares inputted content with stored contents from the database 14. It utilizes the initial word of the inputted content for contrast. Of course, a user may continue to enter more words of the content to shrink the contrasted content range and do a more accurate search. Nevertheless, the disclosed invention does not require all sentence contents, but simply the initial word of the sentence inputted by a user. The system then instantly displays matched sentences from the database 14.

(3)The database adjustment module 13 mainly processes sentence expansion or removal from the database 14 according to the operations of a user. When a user wants to expand a sentence through the input interface, the database adjustment module 13 judges if the sentence already exists in the database. If YES, the system informs the user with a simple message through a popup window and ends the process of sentence expansion. If NO, the system determines whether there is any long paragraph needs to be divided into shorter sentences. This means that the system separates a longer paragraph based on full stops of the inputted content. It is more convenient for subsequent sentence selections when a long paragraph is accurately and properly divided, and it saves a user's time in manually editing a paragraph. As to the process of sentence removal, the database adjustment module 13 helps to directly delete a corresponding sentence in the database 14 if a user chooses to remove a sentence by executing a combination of defined keys.

Those defined keys for a user to remove a sentence have to be a combination of key selections that are elected keys assigned to those displayed sentences (e.g. numbers 6˜0, or function keys F1˜F12) and pre-set defined keys. That is, execution of sentence removal must be processed through combined keys.

(4)The database 14stores all built-in contents of the system and expanded contents from a user.

In fact, the disclosed invention further provides a definition set-up module 15. It mainly processes various settings of the input interface module 11, the contrast display module 12 and the database adjustment module 13, such as definition setting of push buttons, setting of display modes, setting of contrast rules, setting of division rules, and setting of expansion rules.

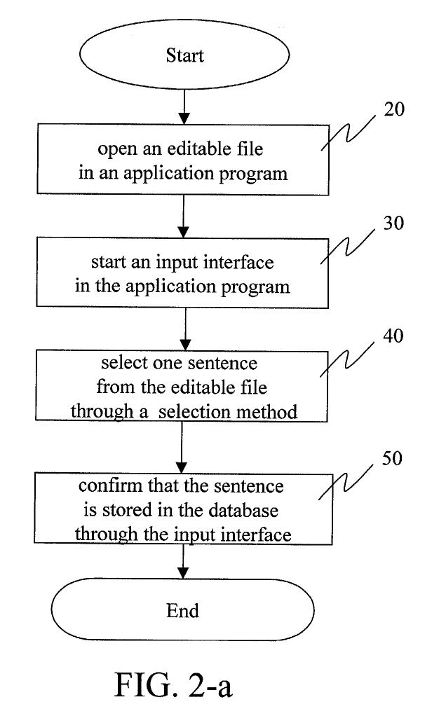

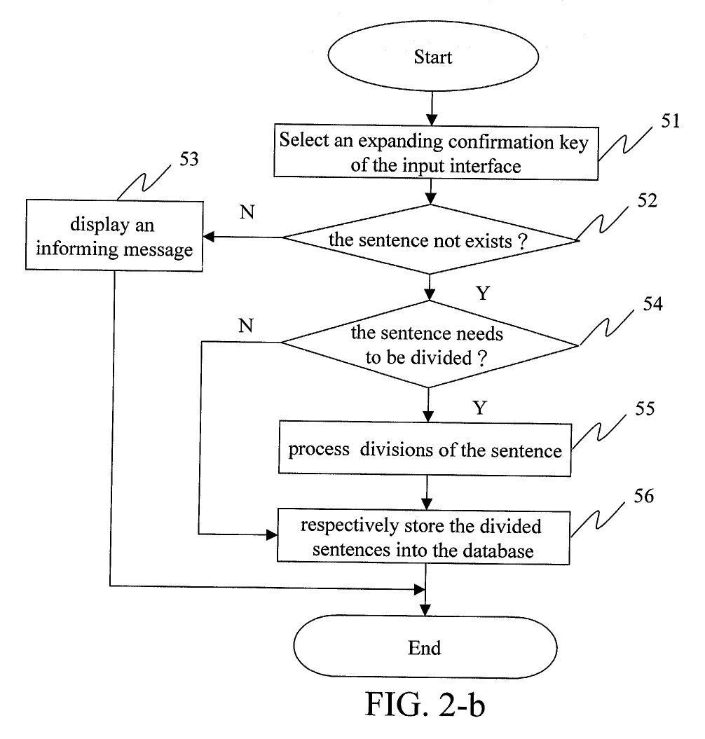

With reference to FIG. 2-a, the flowchart for expanding the database according to the disclosed system and method is described as follows.

When a user wants to expand a sentence from another application program file into the database 14, s/he has to execute the application program and open an editable file that has the desired sentence (step 20). The application program software then starts up the input interface of the disclosed invention (step 30). The user is capable of processing any sentence/paragraph expansion from the editable file by highlighting the sentence. The highlighted sentence is the content to be expanded into the database 14 (step 40). Finally, the user directly stores the highlighted sentence by executing an expanding confirmation key provided by the input interface (step 50). The system then ends the sentence expansion process.

The detailed flow of expanding the database according to the disclosed system and method is further described by FIG. 2-b. The details are as follows.

When the user pushes the expanding confirmation key provided by the input interface (step 51), the disclosed system checks if the sentence highlighted by the user is in the database 14 (step 52). If YES, it is not necessary for the user to expand the sentence into the database, so the system informs the user with a simple message in a popup window and ends the process of sentence expansion (step 53). If NO, the system determines whether the sentence/paragraph is long enough and whether it needs to be divided into shorter sections (step 54). If NO, the system directly expands the sentence into the database 14 (step 56); or the system processes sentence/paragraph divisions (step 55). The evaluation and the process of paragraph divisions are based on full stops of the long sentence/paragraph. When there is more than one full stop in the sentence/paragraph, it can be properly divided and stored in the database. Therefore, sentences of any length can be expanded into the database 14 after being divided appropriately.

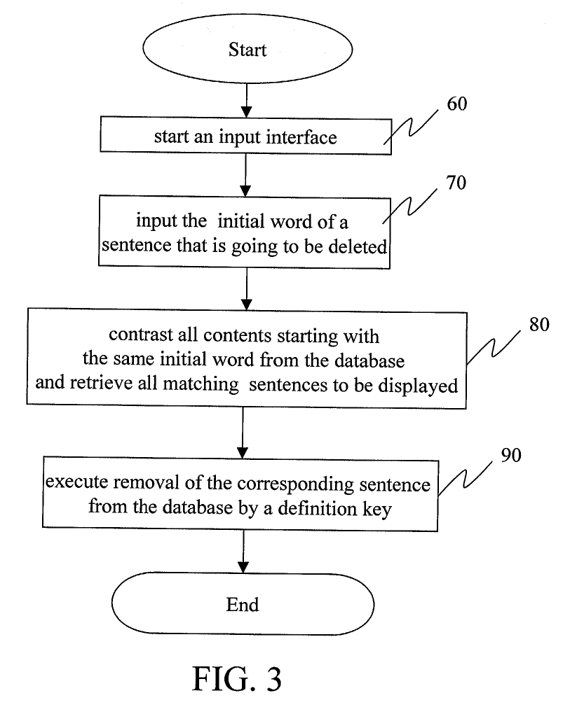

Sentence removal is described in FIG. 3, a flowchart for removing the database according to the disclosed system and method.

To execute the process of sentence removal, the system also needs to activate the input method and its input interface (step 60). The user then inputs the initial word of a sentence that is to be deleted (the user is not required to input all words of the sentence, as the disclosed system requires only a few words to contrast with the database contents and retrieve and display matching sentences. The user may continue to enter more words to reduce the contrast range for a more accurate search.)(step 70). The system contrasts inputted words with corresponding sentences in the database 14 and displays matching data (step 80). The user then deletes a chosen sentence in the database by defined set-up keys (step 90), which are both elected keys assigned to those displayed sentences (e.g. numbers 6˜0, or function keys F1˜F12) and pre-set defined keys. Therefore, execution of sentence removal must be processed through combined keys.

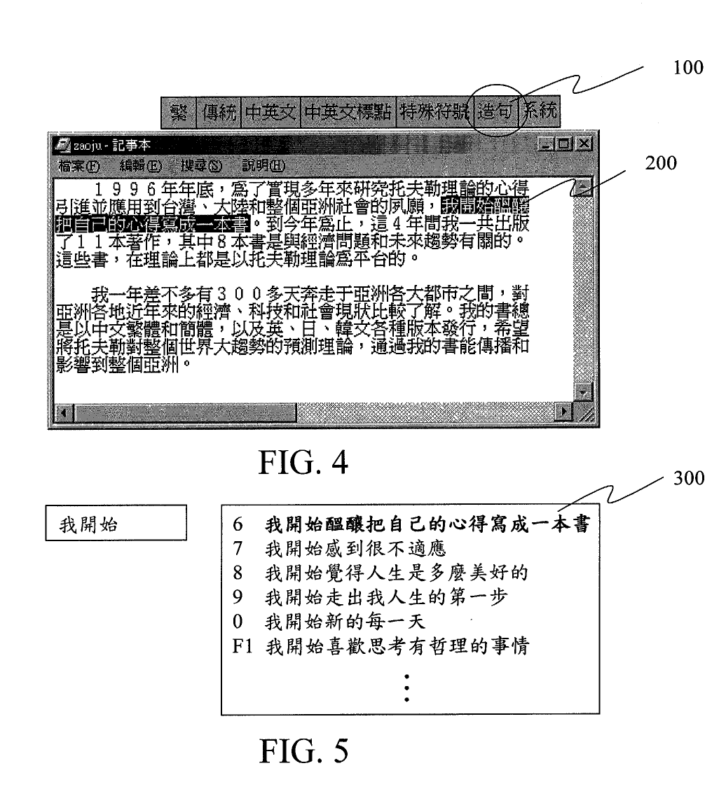

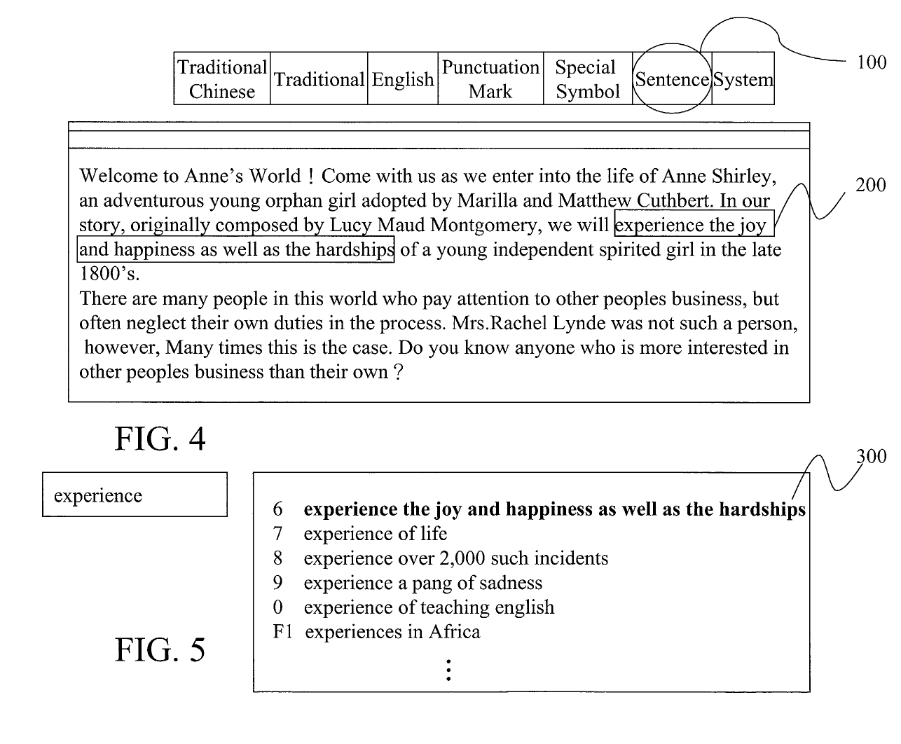

The feasibility and practicality of the invention will be elaborated by means of embodiments depicted in FIGS. 4 and 5 as follows.

When a user wants to expand one sentence in the application program of the “ [symbol] ” (as shown in FIG. 4, the sentence “ [symbol] ”), s/he has to start up the input interface of the disclosed invention, highlight the sentence 200 and hit the expanding confirmation key 100 of the input interface to immediately store the sentence in the database 14. When a user wants to delete the previously expanded sentence from the database 14, s/he only needs to input the initial word “ [symbol] ” of the sentence 300 (as shown in FIG. 5, the sentence 300 “ [symbol] ”). The system then finds and retrieves all sentences starting with “ [symbol] ”, including the sentence 300 to be deleted. The user may input more words (as shown in FIG. 5 “ [symbol] ”) to make the system reduce the search range for more accurate contrasts. Therefore, when the user finds the sentence 300 displayed, s/he can removes the sentence 300 from the database 14 through defined set-up keys, which consist of an elected key assigned to each displayed sentence (as shown in FIG. 5 number “6”) and a pre-set defined key (assuming it to be “SHIFT”). A user merely selects the “SHIFT” key and number key “6” to remove the sentence 300

[symbol]

### Achievements of the Invention

The disclosed system and method of input with a dynamic database adjustment function enables a user to select a sentence from an editable file of any application program to be expanded into the database while the input method is activated. It not only allows a user to quickly search the database at any time, but also processes expansion and removal of a database sentence while activating the input method. It is more flexible and convenient for a user to dynamically use the adjustable database, which contains sentences that a user frequently uses. It increases a user's interest in using it because his/her preferred sentences are in the database, and it also greatly heightens a user's input speed.

In addition, the sentence expansion design of the disclosed system utilizes the function of automatically dividing a selected run-on sentence into accurate sentences to be stored in the database. This makes it possible to store long sentences in the database, saving a user's time in editing sentences him/herself and with more accurate and logical sentences in the database for convenience. The system provides a user with a popup window to inform him/her of the status of sentence expansion, enabling the user to save time inputting sentences in the database.

As previously stated, detailed embodiments of the invention are disclosed herein. However, it is to be understood that the disclosed embodiments are merely exemplary of the invention that may be embodied in various forms. These and other variations, which will be understood by those skilled in the art, are within the intended scope of the invention as claimed below.

What is claimed is:

1. A system of input with a dynamic database adjustment function that enables to select a sentence to be expanded into the database while the system is activating, the system comprising:
a database, to store all built-in contents of the system and expanded contents from a user;
an input interface module, to provide the user with an input interface to proceed switches of different input modes, execution of various functions and input selections;
a contrast and display module, to compare inputted contents of the user with contents stored in the database and instantly display matched contents retrieved from the database;
a database adjustment module, to proceed sentence expansion or removal of the database based on the operations of the user.

2. The system of claim 1, wherein the system provides the function of optionally removing a chosen sentence from the database.

3. The system of claim 1, wherein the system further comprising a definition set-up module, to set up the input interface module, the contrast display module and the database adjustment module.

4. The system of claim 1, wherein the way of “instantly displaying” utilizes a popup window for showing a message.

5. A method of input with a dynamic database adjustment function that enables to directly select a sentence to be expanded into the database while the method is activating, the method comprising the following steps:
opening an editable file from an application program;
starting an input interface of the application program;
selecting a sentence from the editable file through a selection method; and
confirming the sentence is stored in the database through the input interface.

6. The method of claim 5, wherein the selection method is to highlight the chosen sentence.

7. The method of claim 5, wherein the step of confirming the sentence is stored in the database through the input interface further comprising the following steps:
selecting an expanding confirmation key of the input interface;
proceeding divisions of the sentence; and
respectively storing the divided sentences into the database.

8. The method of claim 7, wherein the step further contains a step of instantly displaying a message to keep a user informed while the sentence exists.

9. The method of claim 8, wherein the way of “instantly displaying” utilizes a popup window for showing a message.

10. The method of claim 7, wherein divisions of the sentence are separated by full stops in the sentence.

11. A method of input with a dynamic database adjustment function that enables to directly select a sentence to be removed from the database while the method is activating, the method comprising the following steps:
starting an input interface;
inputting the initial word of a sentence that is to be deleted;
contrasting all sentences in the database starting with the same initial word and retrieving all matched sentences to be displayed;
removing the correspondent sentence from the database by a defined set-up key.

12. The method of claim 11, wherein the defined set-up key is combine with two buttons, in which one has to be an elected key assigned to each displayed sentence.
